(19) United States
(12) Patent Application Publication
(10) Pub. No.: US 2015/0155758 A1
(43) Pub. Date: Jun. 4, 2015

(54) Apparatus, Method and System For Dual Speed Generation

(71) Applicant: Flux Drive, Inc., Kent, WA (US)

(72) Inventor: Philip Corbin, III, Kent, WA (US)

(73) Assignee: Flux Drive, Inc., Kent, WA (US)

(21) Appl. No.: 14/407,461

(22) PCT Filed: Jun. 11, 2013
(86) PCT No.: PCT/US13/45168

§ 371 Date: Dec. 11, 2014

Related U.S. Application Data
(60) Provisional application No. 61/658,676, filed on Jun. 12, 2012.

(51) Int. Cl. H02K 7/18; F16H 37/06

(52) U.S. Cl. CPC H02K 7/1807; F16H 37/06

(57) ABSTRACT

The present invention relates to an apparatus, method and system for dual speed power transfer, wherein the prime mover power generating device would run at 1200 Revolutions/Minute [RPM] with the connected driven load electrical generator running at 1800 RPM; or, an apparatus, method and system for dual speed power transfer, wherein the prime mover power generating device would run at 1800 Revolutions/Minute [RPM] with the connected driven load electrical generator running at 1800 RPM. Also to note 50 hz. Operations (1500 rpm—Generator) and reduced speed (1200 rpm or less), or other speed as could be chosen and designed.

### BACKGROUND AND SUMMARY OF THE INVENTION

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

This rotational torque and power transfer system's basic operation is that during a speed transfer/change of the Prime Mover (Engine), the Generator remains running at a constant speed (1800 rpm/60 hz, or 1500 rpm/50 hz) while the Prime Mover reduces its speed from 1800 RPM to 1200 RPM (in order to optimize engine operation and reduce wear, emissions, and fuel consumption). A major operational goal is to keep producing power (at 60 hertz and synchronized—if running in parallel), during the engine speed transfer without any electrical disruption.

Note that the two (2) Flux Drive ASDs [‘ASD’=Adjustable Speed Drive] (as shown) will allow the Prime Mover (Engine) speed to change during the transfer from 1800 rpm to 1200 rpm, while keeping the Generator rotating at 1800 rpm and producing quality power. By using the Flux Drive ASDs, no components will wear out due to transient speeds generated during the speed changes of the engine and this drive system also has a very high efficiencies since full and reduced power operation of the Flux Drive ASDs will be at 98% efficiency (2% slip, or possibly even less at full engagement—lockup).

As such, those skilled in the art will appreciate that the conception, upon which this disclosure is based, may readily be utilized as a basis for the designing of other structures, methods and systems for carrying out the several purposes of the present invention. It is important, therefore, that the limited claims herein be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention. Description of selected embodiments of the invention included herein are listed as follows:

FIG. 1 is a plan view of an arrangement of a preferred embodiment of the invention (Off-set, Belt Driven: Prime Mover-Generator arrangement); said view showing the 1800 RPM Prime Mover rotational speed with a 1800 RPM Generator rotational speed.

FIG. 2 is a plan view of an arrangement of a preferred embodiment of the invention (Off-set, Belt Driven: Prime Mover-Generator arrangement); said view showing the 1200 RPM Prime Mover rotational speed with a 1800 RPM Generator rotational speed.

FIG. 3 is a plan view of an arrangement of a preferred embodiment of the invention (In-Line, Direct Driven: Prime Mover-Generator arragnement); said view showing the 1800 RPM Prime Mover rotational speed with a 1800 RPM Generator rotational speed.

FIG. 4 is a plan view of an arrangement of a preferred embodiment of the invention (In-Line, Direct Driven: Prime Mover-Generator arrangement); said view showing the 1200 RPM Prime Mover rotational speed with a 1800 RPM Generator rotational speed.

### DESCRIPTION OF THE PREFERRED EMBODIMENT

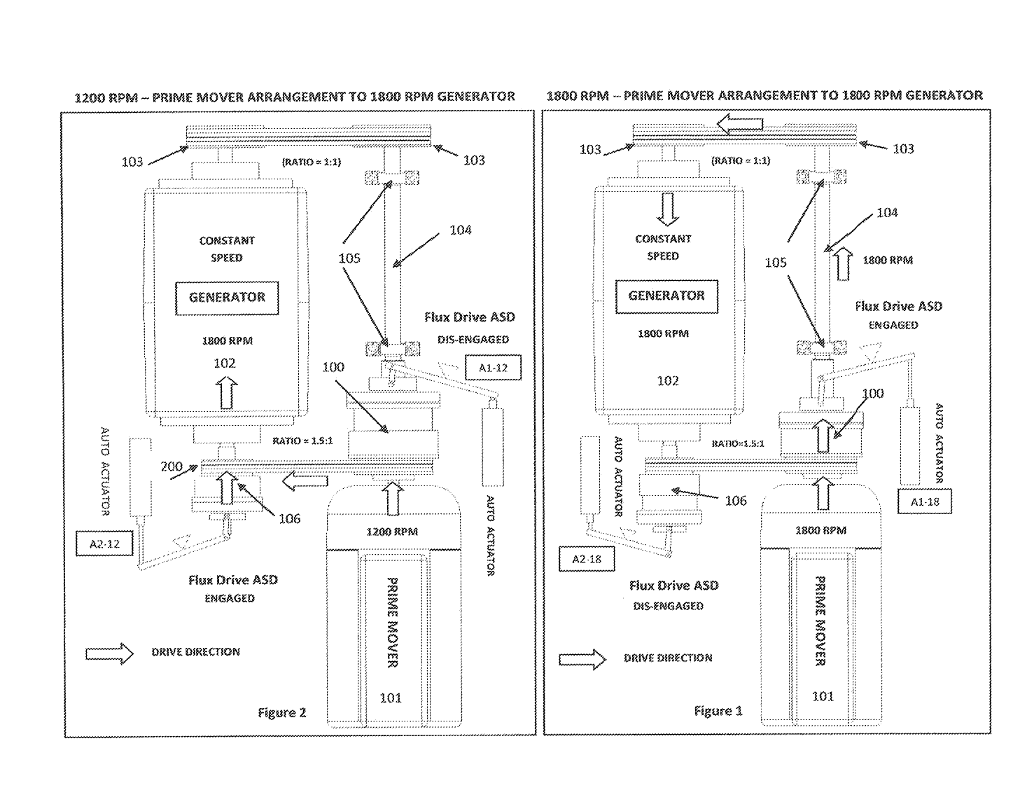

With reference now to the drawings, FIGS. 1 through 4, the preferred embodiment of the invention embodying the principles and concepts of the present invention.

How this rotational torque and power system transfer works—

1800 RPM Operation: (See Attached Drawing: 1800 RPM Prime Mover to 1800 RPM Generator)—FIG. 1 (Off-set, Belt Driven: Prime Mover-Generator arrangement);

An in-line Flux Drive ASD (100) (with Automatic Actuator A1-18 engaged) will allow the Prime Mover (101) to drive the Generator (102) via a 1:1 belt drive (103) ratio (at 1800 rpm) to the non drive-end (NDE) of the Generator (102), off-set mounted next to a drive line/shaft (104) running in-line with the Prime Mover (101). This drive shaft (104) has two (2) pedestal bearings (105) for support, and a pulley/sheave (103) at its end driving a matching pulley/sheave (103) mounted on the Generator (102) with a drive (Ratio=1:1). The generator (102) mounted Flux Drive ASD (106) (with Automatic Actuator A2-18) is disengaged (with Automatic Actuator A2-18) during this mode of operation. (This condition=full speed/power operation)

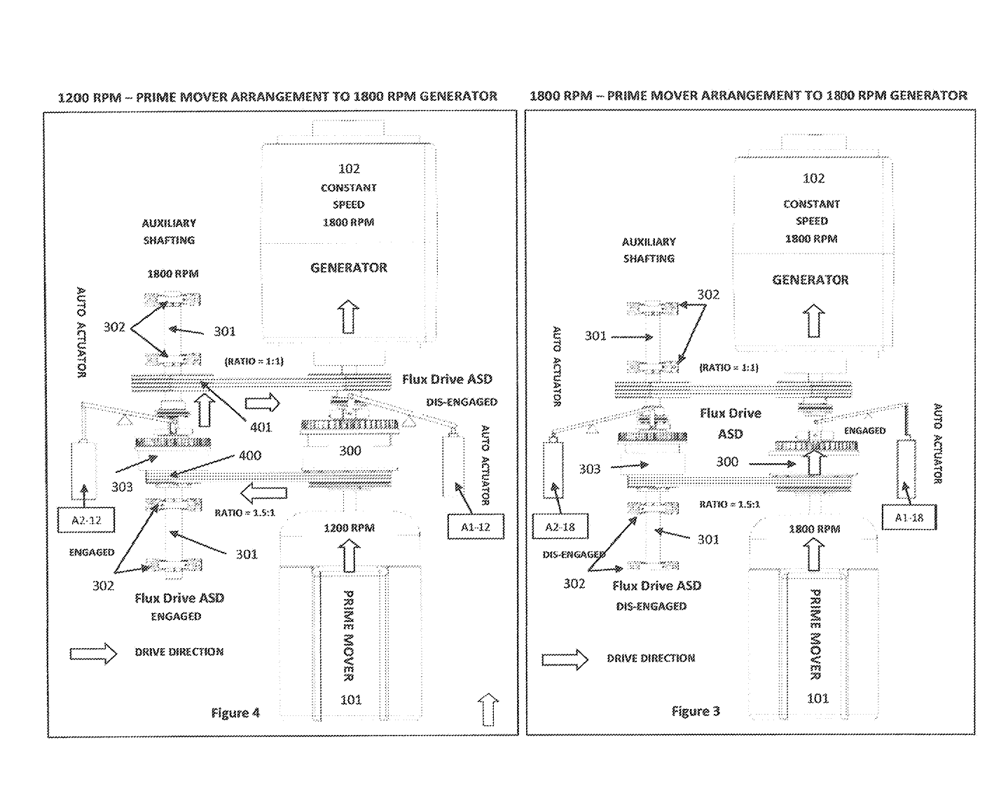

1800 RPM Operation: (See Attached Drawing: 1800 RPM Prime Mover to 1800 RPM Generator)—FIG. 3 (In-Line, Direct Driven: Prime Mover-Generator arragnement);

An in-line Flux Drive ASD (300) (with Automatic Actuator A1-18 engaged) will allow the Prime Mover (101) to drive the Generator (102) direct driven (at 1800 rpm) to the drive-end (DE) of the Generator (102). The Auxiliary Shafting (301), supported by four bearings (302) is disengaged by Flux Drive ASD (303) (with Automatic Actuator A2-18) during this mode of operation. (This condition=full speed/power operation)

1200 RPM Operation: (See Attached Drawing: 1200 RPM Prime Mover to 1800 RPM Generator)—FIG. 2 (Off-set, Belt Driven: Prime Mover-Generator arrangement);

The generator (102) mounted Flux Drive ASD (106) (with Automatic Actuator A2-12) will allow the Prime Mover (101) to slow down to 1200 rpm (while keeping the Generator (102) speed at 1800 rpm). This is accomplished by the secondary, Flux Drive ASD (106) (with Automatic Actuator A2-12) engaging to speed up the second drive pulley/sheave combo (200) at the Drive End (DE) Generator (102). This 2nd Flux Drive ASD (106) is engaged during this speed transient (1800 to 1200 rpm of the Engine), thereby keeping the Generator (102) running at 1800 rpm/60 hertz. The primary (in-line) drive shaft Flux Drive ASD (100) (with Automatic Actuator A1-12) is dis-engaged during this speed transfer transient of the Prime Mover (101).

Automatic ‘computer programmed’ electronic linear actuators (A1-12 and A2-12) will take a control signal that the engine speed control system will provide during the speed change of the Prime Mover (101)

The end result is that the Generator (102) remains running at constant speed during the Prime Mover (101) speed reduction to 1200 rpm (and also during the prime mover speed up to 1800 rpm).

Note: 1200:1800 rpm (1.5 speed up ratio—1200 rpm to 1800 rpm) on the secondary drive pulley/sheave (200) of the Flux Drive ASD (106).

1200 RPM Operation: (See Attached Drawing: 1200 RPM Prime Mover to 1800 RPM Generator)—FIG. 4 (In-Line, Direct Driven: Prime Mover-Generator arrangement);

The Auxiliary Shaft (301) mounted with Flux Drive ASD (303) (with Automatic Actuator A2-12) will allow the Prime Mover (101) to slow down to 1200 rpm (while keeping the Generator (102) speed at 1800 rpm). This is accomplished by the secondary, Flux Drive ASD (303) (with Automatic Actuator A2-12), mounted on the off-set Auxiliary shafting (301), fitted with four bearings (302), engaging to speed up the second drive pulley/sheave combo (400) at the Drive End (DE) of the Auxiliary Shafting (301) to 1800 RPM. A matching pulley/sheave (401) mounted on the generator-end of the Auxiliary Drive shaft (301), drives the Generator (102) with an equal drive ratio (Ratio=1:1). This 2nd Flux Drive ASD (303) is engaged during this speed transient (1800 to 1200 rpm of the prime mover), thereby keeping the Generator (102) running at 1800 rpm/60 hertz. The primary (in-line) drive shaft Flux Drive ASD (300) (with Automatic Actuator A1-12) is dis-engaged during this speed transfer transient of the Prime Mover (101). Automatic ‘computer programmed’ electronic linear actuators (A1-12 and A2-12) will take a control signal that the engine speed control system will provide during the speed change of the Prime Mover (101).

The end result is that the Generator (102) remains running at constant speed during the Prime Mover (101) speed reduction to 1200 rpm (and also during the prime mover speed up to 1800 rpm).

Note: 1200:1800 rpm (1.5 speed up ratio—1200 rpm to 1800 rpm) on the secondary

Auxiliary shaft (301) pulley/sheave drive (400) of the Flux Drive ASD (303).

It is therefore contemplated that the instant disclosure will embrace any such alternatives, modifications and variations as falling within the true scope and spirit of the present invention.

In so far as the description above and the accompanying drawings disclose any additional subject matter that is not within the scope of the claims below, the inventions are not dedicated to the public and the right to file one or more applications to claim such additional inventions is reserved.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. An apparatus for efficient power transfer between two rotating shafts, said apparatus comprising:
A prime mover mechanical torque and power generating device operating at a particular rotational speed,
An electrical generator torque and power using device operating at another particular rotational speed,
Said prime mover and said electrical generator being rotationally interconnected through a rotational torque and power system, said system comprising a plurality of adjustable speed drive magnetic torque converters and a plurality of mechanical rotational torque transfer devices,
said rotational torque and power transfer system allowing for continuous rotational torque and power transfer between said prime mover and said electrical generator during any desired changes in the rotational speeds of said prime mover or said electrical generator.

2. The apparatus of claim 1, wherein said rotational torque and power transfer system's mechanical rotational torque transfer devices comprises a plurality of pulleys and sheaves.

3. The apparatus of claim 1, wherein said rotational torque and power transfer system's mechanical rotational torque transfer devices comprises a plurality of meshing gears.

4. The apparatus of claim 1, wherein said adjustable speed drive magnetic torque converters comprise devices that transfer rotational torque and power through variable magnetic field interaction between said torque converters' shafts.

5. A method for efficient power transfer between two rotating shafts, said method comprising:
Having a a prime mover mechanical torque and power generating device operating at a particular rotational speed,
Having a electrical generator torque and power using device operating at another particular rotational speed,
Said prime mover and said electrical generator being rotationally interconnected through a rotational torque and power system, said system comprising a plurality of adjustable speed drive magnetic torque converters and a plurality of mechanical rotational torque transfer devices,
said rotational torque and power transfer system allowing for continuous rotational torque and power transfer between said prime mover and said electrical generator during any desired changes in the rotational speeds of said prime mover or said electrical generator.

6. The method of claim 5, wherein said rotational torque and power transfer system's mechanical rotational torque transfer devices comprises a plurality of pulleys and sheaves.

7. The method of claim 5, wherein said rotational torque and power transfer system's mechanical rotational torque transfer devices comprises a plurality of meshing gears.

8. The method of claim 5, wherein said adjustable speed drive magnetic torque converters comprise devices that transfer rotational torque and power through variable magnetic field interaction between said torque converters' shafts.

9. A system for efficient power transfer between two rotating shafts, said system comprising:
Having a a prime mover mechanical torque and power generating device operating at a particular rotational speed,
Having a electrical generator torque and power using device operating at another particular rotational speed,
Said prime mover and said electrical generator being rotationally interconnected through a rotational torque and power system, said system comprising a plurality of adjustable speed drive magnetic torque converters and a plurality of mechanical rotational torque transfer devices,
said rotational torque and power transfer system allowing for continuous rotational torque and power transfer between said prime mover and said electrical generator during any desired changes in the rotational speeds of said prime mover or said electrical generator.

10. The system of claim 9, wherein said rotational torque and power transfer system's mechanical rotational torque transfer devices comprises a plurality of pulleys and sheaves.

11. The system of claim 9, wherein said rotational torque and power transfer system's mechanical rotational torque transfer devices comprises a plurality of meshing gears.

12. The system of claim 9, wherein said adjustable speed drive magnetic torque converters comprise devices that transfer rotational torque and power through variable magnetic field interaction between said torque converters' shafts.
